(19) United States
(12) Patent Application Publication
(10) Pub. No.: US 2018/0154708 A1
(43) Pub. Date: Jun. 7, 2018

(54) TIRE SENSOR AND METHOD OF MANUFACTURING THE SAME

(71) Applicants: TAE HOON YANG, GYEONGGI-DO (KR); JIN KYU HWANG, INCHEON (KR); SUNG MIN CHO, GYEONGGI-DO (KR); SANG HOON LIM, GYEONGGI-DO (KR)

(72) Inventors: TAE HOON YANG, GYEONGGI-DO (KR); JIN KYU HWANG, INCHEON (KR); SUNG MIN CHO, GYEONGGI-DO (KR); SANG HOON LIM, GYEONGGI-DO (KR)

(73) Assignee: INFAC ELECS CO., LTD., GYEONGGI-DO (KR)

(21) Appl. No.: 15/425,511

(22) Filed: Feb. 6, 2017

(30) Foreign Application Priority Data
Dec. 2, 2016 (KR) 10-2016-0163909

(51) Int. Cl. B60C 23/04; G01M 17/02

(52) U.S. Cl. CPC B60C 23/0452; G01M 17/02

(57) ABSTRACT

Disclosed herein is a tire sensor which includes a printed circuit board including an antenna matching circuit unit for matching a frequency corresponding to an antenna frequency, and a detection unit for detecting tire information, an antenna coupled to one side of the printed circuit board so as to transmit or receive the information detected by the detection unit to or from the outside, a battery coupled to the other side of the printed circuit board so as to supply electric power to the printed circuit board, and a sensor cover configured to accommodate the printed circuit board, the antenna, and the battery therein, one surface of the sensor cover being fixedly bonded into a tire.

### CROSS-REFERENCE TO RELATED APPLICATIONS

This application claims priority to Korean Patent Application No. 10-2016-0163909, filed on Dec. 2, 2016, the disclosure of which is incorporated herein by reference in its entirety.

### BACKGROUND OF THE INVENTION

### Field of the Invention

Exemplary embodiments of the present invention relate to a tire sensor for measuring a tire pressure, and more particularly, to a tire sensor capable of being easily mounted to a tire.

### Description of the Related Art

Automobile manufacturers currently cope with the “FMVSS138 RULE of the National Highway Traffic Safety Administration (NHTSA) that requires the installation of tire pressure warning systems to vehicles.

A tire pressure warning system mounted to a vehicle is called a tire pressure monitoring system (hereinafter, referred to as “TPMS”). The TPMS is a system which includes a tire pressure sensor (hereinafter, referred to as “TPS”) attached to each of four tires of the vehicle while having an unique ID, and transmits radio waves to the unique ID using a transmitter as one component of radio equipment to read the ID of the TPS so that a driver checks and manages the tire of his/her own vehicle through a vehicle ECU (Electronic control unit) based on the read ID value.

In order to export new vehicles to the USA since September, 2007, TPMSs must be obligatorily mounted to the vehicles. The installation of TPMSs has been mandatory all over the world, and it will be mandatory in Europe in November, 2014, in Russia in January, 2016, and in China in 2017. In Korea, it has been required to mount TPMSs to new vehicles which include passenger vehicles and vehicles having a gross weight of 3.5 tons or less, such as vans, trucks, and special vehicles, since Jan. 1, 2013. The reason this regulation is forcibly stipulated is because an accident occurs due to the lack of tire pressure when the vehicle continues to travel at a high speed in the state in which the tire pressure is equal to or less than 25%. That is, a puncture phenomenon in which the inner and outer portions of a tire are separated from each other may occur due to the standing wave of the tire when the vehicle travels at a high speed.

FIG. 1 illustrates a typical tire pressure monitoring system.

Referring to FIG. 1, the tire pressure monitoring system includes a pressure sensor 10, an ECU 20, and a display 30.

The pressure sensor 10 is mounted to each of four wheels W of a vehicle C in such a manner that the air inlet of the pressure sensor is fitted into the air inlet of the wheel. The pressure sensor 10 mounted to the wheel W detects the pressure in a tire and transmits the detected value to the display 30.

The pressure sensor may be provided with an antenna for transmitting data to the ECU after detecting the pressure of the tire. The display 30 is disposed within a driver's viewing area and is typically mounted to a dashboard on an instrument panel.

However, since the pressure sensor 10 for the conventional tire pressure monitoring system is fixed to the wheel in such a manner that the air inlet of the pressure sensor is fitted into the air inlet of the wheel, the pressure sensor may be restrictively mounted according to the specification of the wheel.

That is, the wheels used for passenger and commercial vehicles have different shapes, structures, and sizes. The tire valve used for the passenger vehicle has a bore of 6 mm or 11.5 mm according to the size of the valve hole of the wheel, and the stem of the tire valve has various lengths according to the design of the wheel.

The wheel of the commercial vehicle is classified into 17.5-inch, 19.5-inch, and 22.5-inch wheels according to the size thereof, is classified into steel and aluminum wheels according to the material thereof, and is classified into cast and forged wheels according to the manufacturing process thereof. As such, the wheel may have different shapes, structures, and sizes in many forms.

Accordingly, a tire sensor must be conventionally designed and manufactured so as to be suitable for each vehicle, and hence the process and cost for manufacturing the tire sensor may be increased.

### PRIOR ART DOCUMENT

[Patent Document]

(Patent Document 1) Korean Patent Laid-open Publication No. 10-2010-0109735

### SUMMARY OF THE INVENTION

An object of the present invention is to provide a tire sensor capable of being easily mounted to a tire.

Another object of the present invention is to provide a tire sensor capable of transmitting tire information to a vehicle display or a user's mobile terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with one aspect of the present invention, a tire sensor includes a printed circuit board including an antenna matching circuit unit for matching a frequency corresponding to an antenna frequency, and a detection unit for detecting tire information, an antenna coupled to one side of the printed circuit board so as to transmit or receive the information detected by the detection unit to or from the outside, a battery coupled to the other side of the printed circuit board so as to supply electric power to the printed circuit board, and a sensor cover configured to accommodate the printed circuit board, the antenna, and the battery therein, one surface of the sensor cover being fixedly bonded into a tire.

The tire sensor may include an RF module of LF communication system in order to transmit the tire information to a vehicle ECU.

The tire sensor may include an RF module of Bluetooth communication system in order to transmit the tire information to a mobile terminal.

The antenna matching circuit unit may include at least one of an RF module for transmitting a signal to the vehicle ECU and a Bluetooth module for transmitting a signal to the mobile terminal.

The printed circuit board may further include a fixing protrusion protruding outward, the fixing protrusion being fixed to the sensor cover.

The antenna may have a sensing hole formed at a position corresponding to the detection unit.

The sensor cover may include a cover body portion accommodating the printed circuit board, the antenna, and the battery therein, and a stepped portion protruding from one side of the cover body portion while being stepped relative to the cover body portion.

The stepped portion may have an antenna hole for transmitting information from the antenna to the outside.

The tire sensor may further include a holder configured to accommodate the cover body portion therein, one surface of the holder being fixedly bonded into the tire.

The holder may include a holder body portion accommodating the cover body portion therein, and a flange portion extending from one side of the holder body portion so as to have a larger diameter than the holder body portion.

In accordance with another aspect of the present invention, a method of manufacturing a tire sensor includes preparing a printed circuit board having at least one fixing protrusion protruding outward from an edge thereof, assembling an antenna to one side of the printed circuit board, assembling a battery to the other side of the printed circuit board, and forming a sensor cover by injection molding of synthetic resin outside the antenna, the printed circuit board, and the battery.

The method may further include cutting the fixing protrusion protruding outward from the sensor cover after the forming a sensor cover.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating a typical tire pressure monitoring system;

FIG. 2 is a perspective view illustrating a coupled state of a tire sensor according to an embodiment of the present invention;

FIG. 3 is an exploded perspective view illustrating a state in which a portion of the components of the tire sensor is disassembled according to the embodiment of the present invention;

FIG. 4 is a perspective view illustrating components in the sensor cover of the tire sensor according to the embodiment of the present invention;

FIG. 5 is a block diagram schematically illustrating the components in the sensor cover of the tire sensor according to the embodiment of the present invention;

FIG. 6 is a flowchart illustrating a process of manufacturing a tire sensor according to an embodiment of the present invention; and

FIG. 7 is a perspective view illustrating the process of manufacturing a tire sensor according to the embodiment of the present invention.

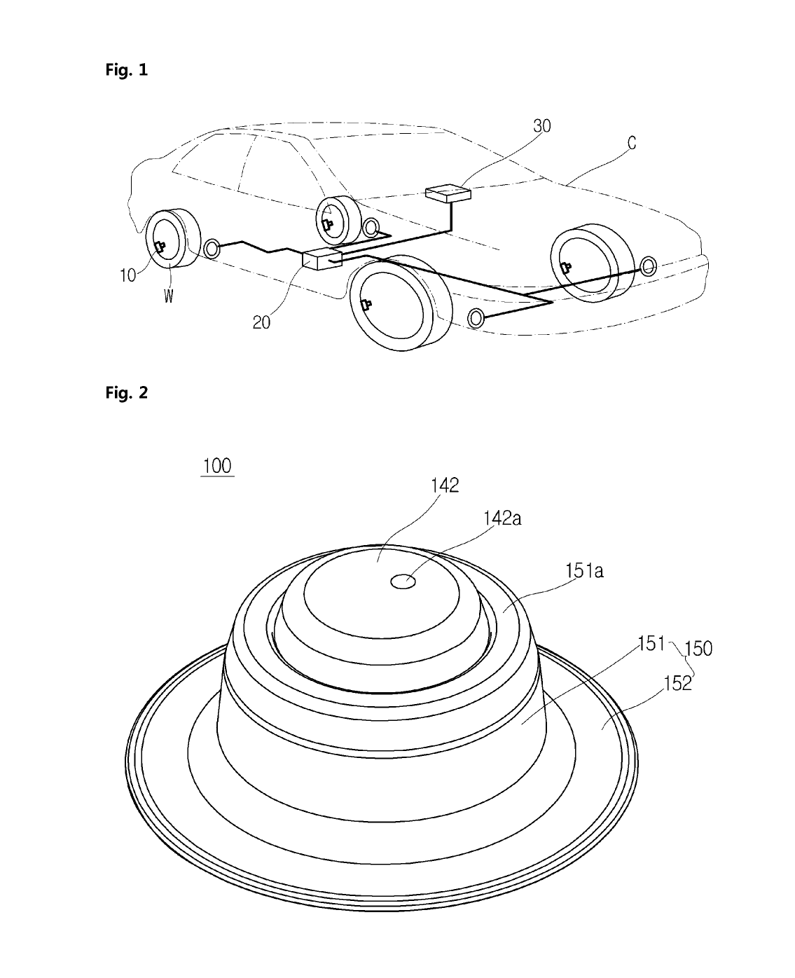

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the whole description, it will be understood that when an element is referred to as being “connected” to another element, it can be “directly connected” to the other element or it can be “electrically connected” to the other element with other elements being interposed therebetween. In addition, it will be understood that when a component is referred to as being “comprising” any component, it does not exclude other components, but can further comprises the other components unless otherwise specified.

Hereinafter, exemplary embodiments of the present invention will be described in detail with reference to the accompanying drawings.

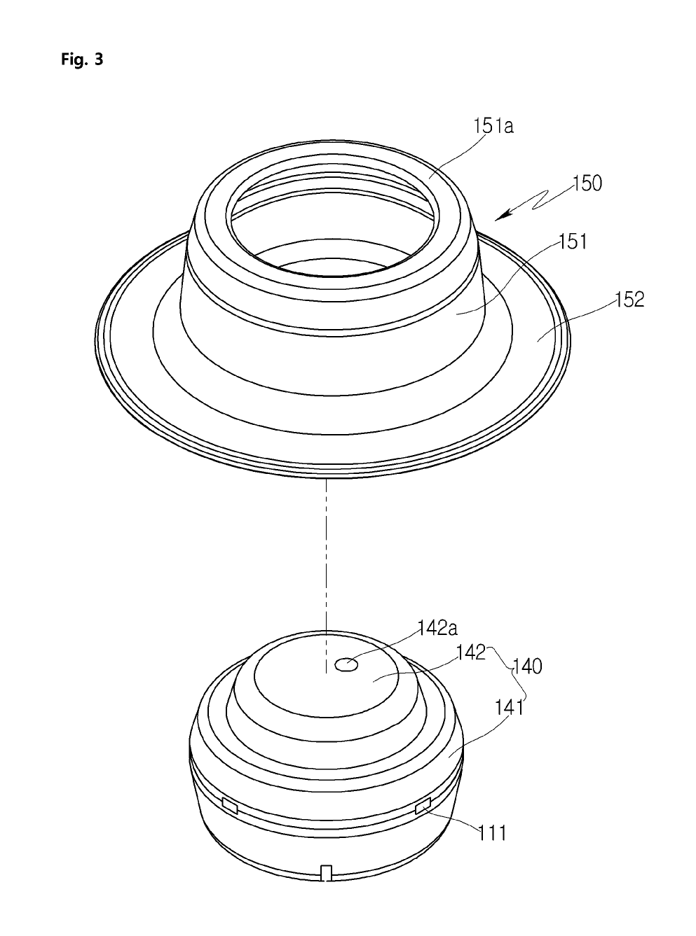

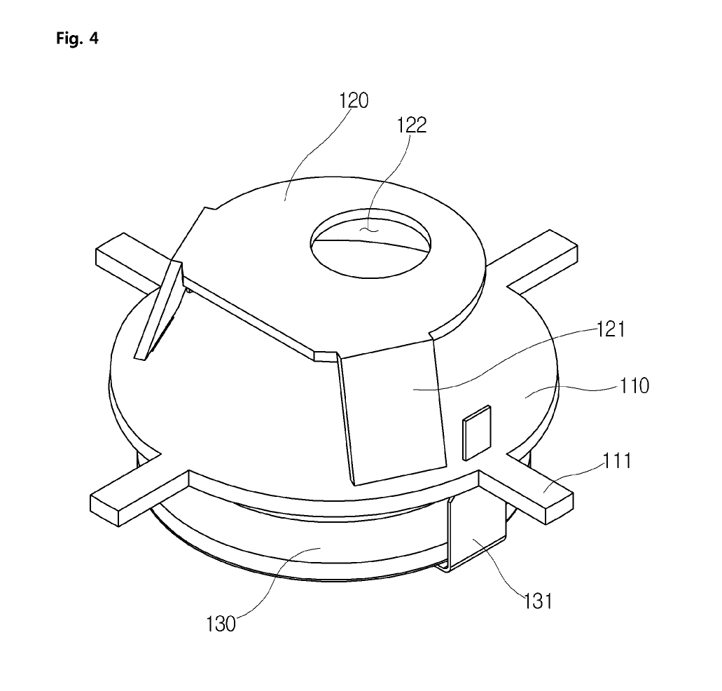

FIGS. 2 and 3 illustrate the external appearance of a tire sensor according to an embodiment of the present invention.

Referring to FIGS. 2 and 3, the tire sensor, which is designated by reference numeral 100, according to the embodiment of the present invention includes a sensor cover 140 which accommodates main components therein, and a holder 150 which is detachably coupled to the outside of the sensor cover 140. The tire sensor is fixedly bonded to the inner surface of a tire by an adhesive member.

The sensor cover 140 includes a cover body portion 141 which accommodates a printed circuit board 110, an antenna 120, and a battery 130 therein, and a stepped portion 142 which protrudes upward from the upper surface of the cover body portion 141.

The cover body portion 141 accommodates the printed circuit board 110, the antenna 120, and the battery 130 therein. Although the cover body portion 141 has a cylindrical shape in the embodiment, the present invention is not limited thereto.

The stepped portion 142 protrudes from the upper surface of the cover body portion 141 while having a smaller diameter than the cover body portion 141. That is, the stepped portion 142 is stepped relative to the cover body portion 141 so as to be seated on the upper surface of the cover body portion 141, thereby increasing the coupling force between the sensor cover 140 and the holder 150. The stepped portion 142 may have an antenna hole 142a formed in the upper surface thereof in order to smoothly transmit information from the antenna 120 to the outside, which will be described later.

The holder 150 includes a holder body portion 151 which accommodates the cover body portion 141 therein, and a flange portion 152 which is formed at the lower side of the holder body portion 151.

The holder body portion 151 has a shape corresponding to the appearance of the cover body portion 141 so as to accommodate the cover body portion 141. The holder body portion 151 is a cylindrical body opened at the upper and lower sides thereof, and has a rim 151a formed at the upper opening thereof, the rim 151a protruding inward so as to be seated on the upper surface of the cover body portion 141.

The flange portion 151 extends outward from the lower end of the holder body portion 151 so as to have a larger diameter than the holder body portion 151. The bottom of the flange portion 152 is fixedly bonded to the inner portion of the tire by an adhesive member such as an adhesive or a double-sided tape.

Here, the bottom of the cover body portion 141 of the sensor cover 140 may be fixedly bonded to the inner portion of the tire by the adhesive member, but there is a concern about the secure bonding therebetween due to a relative small bonding area. Thus, in order to increase the bonding between them, after the holder 150 is coupled to the outside of the sensor cover 140 and the adhesive member is applied to the flange portion 152 of the holder 150 having a larger diameter than the cover body portion 141, the flange portion 152 is bonded to the inner portion of the tire.

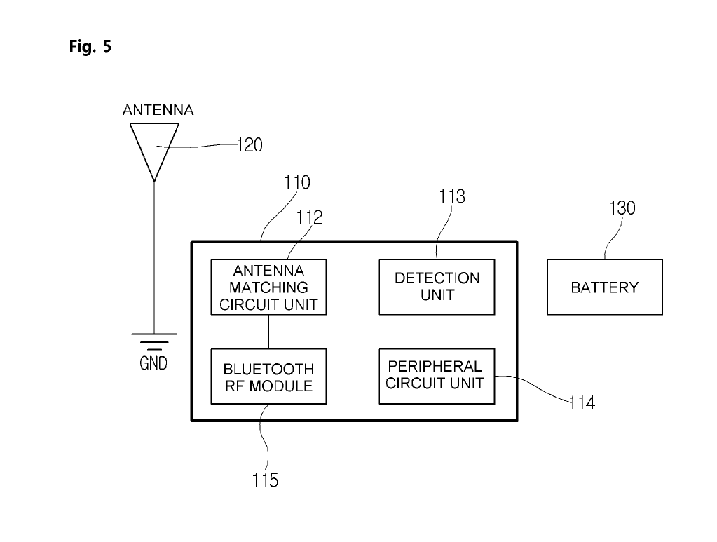

FIGS. 4 and 5 illustrate the components in the sensor cover of the tire sensor according to the embodiment of the present invention.

Referring to FIGS. 4 and 5, the printed circuit board 110, the antenna 120, and the battery 130 are accommodated in the sensor cover.

The printed circuit board 110 has a circuit formed on one surface thereof, and has at least one cover fixing protrusion 111 formed on the edge thereof, the cover fixing protrusion 111 protruding outward. In the embodiment, the cover fixing protrusion 111 consists of four cover fixing protrusions which are formed at equal intervals on the edge of the printed circuit board 110.

The printed circuit board 110 includes an antenna matching circuit unit 112 for matching the antenna according to a frequency band, a detection unit 113 for detecting the acceleration, pressure, temperature, etc. of the tire, a peripheral circuit unit 114, and a Bluetooth RF module 115.

In the embodiment, the tire sensor 100 may provide tire pressure information to a driver using at least one of an RF module of 433.92 MHz LF (low frequency) communication system and an RF module of 2.4 GHz Bluetooth communication system (there is no need for LF communication system). For example, the peripheral circuit unit may include the RF module of LF communication system. When the RF module of 433.92 MHz LF communication system is used, the tire information input through the detection unit is transmitted to a vehicle ECU, and the ECU displays the above information on the display located at a driver's viewing distance. When the RF module of 2.4 GHz Bluetooth communication system is used, the tire information detected by the detection unit is directly transmitted to a user's mobile terminal, and thus the user may recognize the tire information through the mobile terminal. In this case, when the RF module of 2.4 GHz Bluetooth communication system is used, the tire pressure information may be transmitted to the mobile terminal such as a mobile phone without separate TPMS and ECU, with the consequence that it is possible to reduce costs compared to the RF module of LF communication system.

The antenna 120 is disposed above the printed circuit board 110, and serves to transmit information about the temperature or pressure of the tire detected by the detection unit 113 to the user or to receive information from the ECU or the mobile terminal. The antenna 120 includes at least one antenna support 121 made of a conductive material, and one end of the antenna support 121 is fixed to the printed circuit board 110 by soldering. The antenna 120 may have a circular shape when viewed from the plane so as to have a maximum area within a limited range, thereby realizing maximum antenna efficiency. The antenna 120 may be made of a conductive material such as copper, stainless steel, or iron. The antenna 120 has a sensing hole 122 formed at a position corresponding to the detection unit 113 mounted on the printed circuit board 110 so as not to hinder the detection unit 113 from detecting tire information.

The battery 130 is disposed beneath the printed circuit board 110, and has two positive and negative terminals 131 and 132 which are fixed to the printed circuit board 110 by soldering in order to supply electric power to a variety of components mounted on the printed circuit board 110.

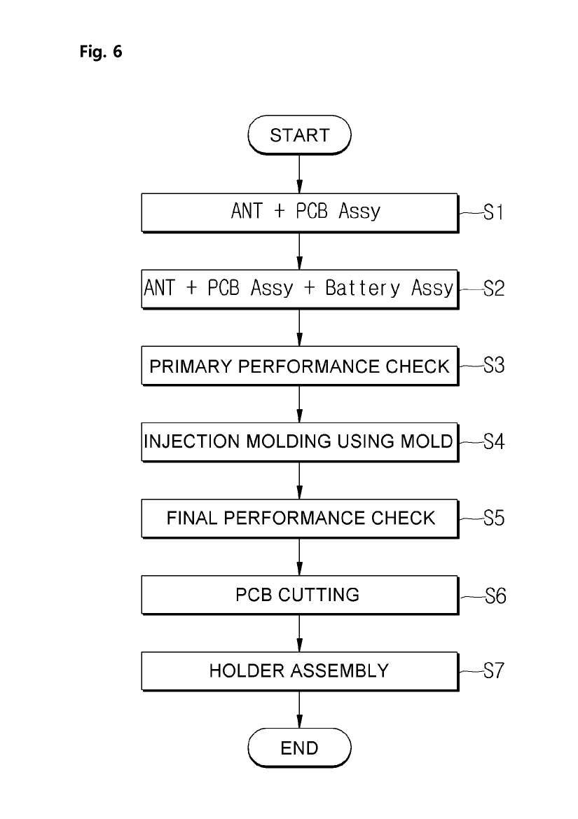

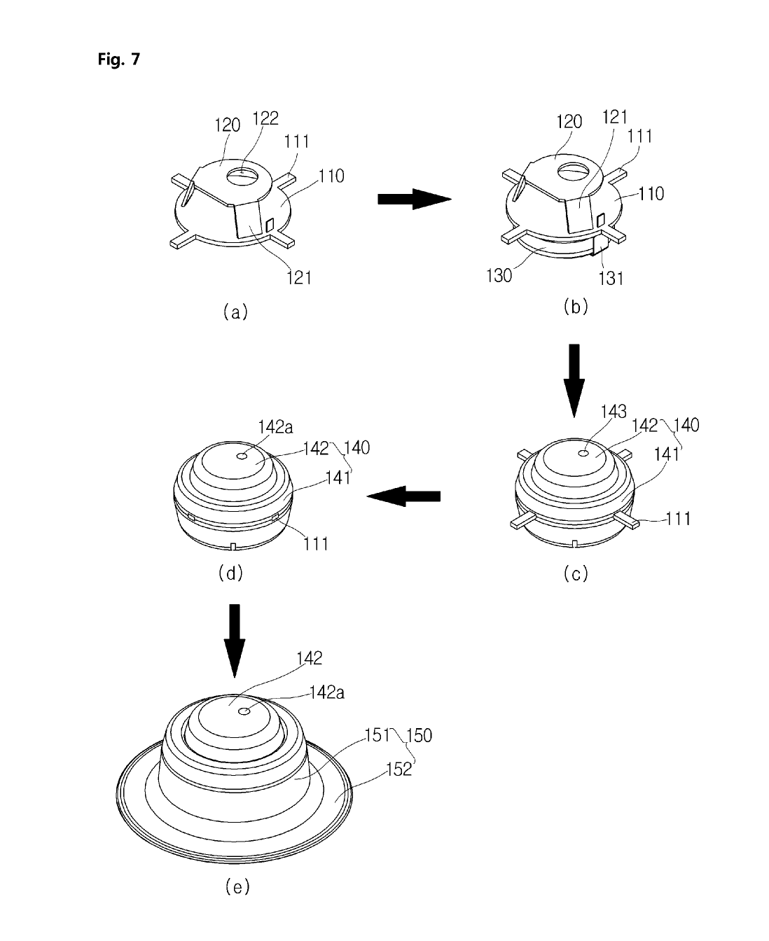

FIGS. 6 and 7 illustrate a process of manufacturing a tire sensor according to an embodiment of the present invention.

Referring to FIGS. 6 and 7, a printed circuit board 110 is first prepared. The printed circuit board 110 is manufactured to have a plurality of fixing protrusions 111 formed on the edge thereof. In the embodiment, the fixing protrusions 111 consist of four fixing protrusions formed at equal intervals. The printed circuit board 110 includes an antenna matching circuit unit 112, a detection unit 113, a peripheral circuit unit 114, and a Bluetooth RF module 115.

An antenna 120 is fixed above the printed circuit board 110 (S1). In the embodiment, the antenna 120 includes two antenna supports 121 made of a conductive material, and the antenna supports 121 are bonded to the upper surface of the printed circuit board 110 by soldering. The antenna 120 has a substantially circular shape, and has a sensing hole 122 formed at a position corresponding to the detection unit 113.

A battery 130 is assembled beneath the printed circuit board 110 (S2). The battery 130 includes two positive and negative terminals 131 and 132 which are bonded to the printed circuit board 110 by soldering.

Subsequently, a sensor cover 140 is formed by injection molding using a mold (not shown) (S4). That is, in the state in which the antenna 120 and the battery are assembled to the printed circuit board 110, the sensor cover 140, which includes a cylindrical cover body portion 141 and a stepped portion 142 formed at the upper side of the cover body portion 141, may be formed by disposing the mold outside the assembly and by injection molding of synthetic resin. In this case, it is necessary to design the mold so as not to seal the sensing hole 122 for detection of a tire pressure when the sensor cover 140 is formed by injection molding. In addition, the stepped portion 142 of the sensor cover 140 has an antenna hole 142a formed in the upper surface thereof in order for the antenna to smoothly perform a communication function. In the embodiment, the process further includes a step of cutting the fixing protrusions of the printed circuit board protruding outward from the sensor cover (S6).

Meanwhile, after the antenna and the battery are assembled to the printed circuit board, a step of primarily checking the performance of the assembly may be performed (S3). In addition, after the sensor cover is assembled, a step of finally checking the detection of tire information and the transmitting and receiving function of the antenna may be performed (S5).

Next, a separate holder 150 formed to correspond to the appearance of the sensor cover 140 may be coupled to the outside of the sensor cover 140 (S7). The holder 150 includes a flange portion 152 which widely extends outward from the lower side thereof. Thus, when an adhesive member is applied to the bottom of the flange portion 152 in order to increase the bonding area with the inner surface of the tire, it is possible to increase the bonding between the tire and the tire sensor.

As is apparent from the above description, according to exemplary embodiments of the present invention, a worker or a user can conveniently assemble a tire sensor since the tire sensor is fixed to the inner surface of a tire by bonding.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A tire sensor comprising:
a printed circuit board comprising an antenna matching circuit unit for matching a frequency corresponding to an antenna frequency, and a detection unit for detecting tire information;
an antenna coupled to one side of the printed circuit board so as to transmit or receive the information detected by the detection unit to or from the outside;
a battery coupled to the other side of the printed circuit board so as to supply electric power to the printed circuit board; and
a sensor cover configured to accommodate the printed circuit board, the antenna, and the battery therein, one surface of the sensor cover being fixedly bonded into a tire.

2. The tire sensor according to claim 1, comprises an RF module of LF communication system in order to transmit the tire information to a vehicle ECU.

3. The tire sensor according to claim 1, comprises an RF module of Bluetooth communication system in order to transmit the tire information to a mobile terminal.

4. The tire sensor according to claim 1, wherein the printed circuit board further comprises a fixing protrusion protruding outward, the fixing protrusion being fixed to the sensor cover.

5. The tire sensor according to claim 1, wherein the antenna has a sensing hole formed at a position corresponding to the detection unit.

6. The tire sensor according to claim 1, wherein the sensor cover comprises a cover body portion accommodating the printed circuit board, the antenna, and the battery therein, and a stepped portion protruding from one side of the cover body portion while being stepped relative to the cover body portion.

7. The tire sensor according to claim 6, wherein the stepped portion further has an antenna hole for transmitting information from the antenna to the outside.

8. The tire sensor according to claim 6, further comprising a holder configured to accommodate the cover body portion therein, one surface of the holder being fixedly bonded into the tire.

9. The tire sensor according to claim 8, wherein the holder comprises a holder body portion accommodating the cover body portion therein, and a flange portion extending from one side of the holder body portion so as to have a larger diameter than the holder body portion.

10. A method of manufacturing a tire sensor, comprising:
preparing a printed circuit board having at least one fixing protrusion protruding outward from an edge thereof;
assembling an antenna to one side of the printed circuit board;
assembling a battery to the other side of the printed circuit board; and
forming a sensor cover by injection molding of synthetic resin outside the antenna, the printed circuit board, and the battery.

11. The method according to claim 10, further comprising cutting the fixing protrusion protruding outward from the sensor cover after the forming a sensor cover.
